(19) United States
(12) Patent Application Publication
(10) Pub. No.: US 2020/0254866 A1
(43) Pub. Date: Aug. 13, 2020

(54) HYBRID POWER DELIVERY SYSTEM FOR AN AIRCRAFT MOVER

(71) Applicant: TEXTRON GROUND SUPPORT EQUIPMENT UK LIMITED, London (GB)

(72) Inventors: Tushar Kulkarni, Gloucestershire (GB); Paul Channon, Gloucestershire (GB)

(21) Appl. No.: 16/845,782

(22) Filed: Apr. 10, 2020

Related U.S. Application Data
(63) Continuation of application No. 15/105,012, filed on Jun. 16, 2016.

(30) Foreign Application Priority Data
Dec. 19, 2013 (GB) 1322544.6

(51) Int. Cl. B60K 6/46; B60L 15/20; B60L 1/00; B64F 1/22; B60K 6/28; B60L 58/12; B60L 50/10; B60L 58/20; B60L 50/40; B60W 20/19; B60L 7/14; B60W 10/26

(52) U.S. Cl. CPC B60K 6/46; B60L 2240/423; B60L 1/003; B64F 1/227; B60K 6/28; B60L 58/12; B60L 50/10; B60L 58/20; B60L 50/40; B60W 20/19; B60L 7/14; B60W 10/26; Y02T 10/6217; Y02T 10/7022; Y02T 10/7005; Y02T 10/7044; Y02T 50/826; Y02T 10/7066; Y02T 10/72; Y02T 90/16; Y02T 10/645; Y02T 10/7283; B60L 2200/40; B60L 2260/28; B60L 2240/441; B60L 2220/44; B60L 15/2045

(57) ABSTRACT

A method of moving an aircraft using an aircraft mover that includes: a] accelerating the aircraft up to speed using one or more electric motors drivable by at least a fast-discharge electrical-energy storage and supply device during a high-power requirement of the aircraft mover; b] substantially maintaining a speed of the aircraft using a slow-discharge electrical-energy storage and supply device during a low-power requirement of the aircraft mover; c] monitoring a charge status of the slow-discharge and fast-discharge energy storage and supply devices and when a predetermined charge status is reached, automatically charging the slow-discharge and/or fast-discharge energy storage and supply devices via an onboard electricity generator; and d] regeneratively recharging the slow-discharge and/or fast-discharge electricity-energy storage and supply devices during at least deceleration of the aircraft coupled to the aircraft mover.

### CROSS-REFERENCE TO RELATED APPLICATIONS

This application is a continuation of U.S. patent application Ser. No. 15/105,012 filed on Jun. 16, 2016, which is a US national stage under 35 U.S.C. § 371 of International Application No. PCT/GB2014/053780, which was filed on Dec. 19, 2014, and which claims the priority of application GB 1322544.6 filed on Dec. 19, 2013, the content of which (text, drawings and claims) are incorporated here by reference in its entirety.

### FIELD

The present teachings relate to a method of moving an aircraft using an aircraft mover, particularly but not necessarily exclusively being an aircraft tractor vehicle, and having a dual electrical-energy storage and supply system. The present teachings further relate to a method of controlling the distribution of power to an aircraft mover, further still to a hybrid power delivery system for an aircraft mover and further still to a dual electrical-energy storage and supply device and control means for controlling the distribution of power of such an electric hybrid aircraft mover.

### BACKGROUND

Aircraft tractors or movers are heavy vehicles which are required to tow and/or maneuver all types of aircraft. In current generation aircraft tractors, there is typically a diesel compression-ignition internal combustion engine, with a direct transmission to a driving axle or wheels. As such, the engine is directly providing the driving power of the tractor.

Aircraft tractors or movers may be required to maneuver a variety of sizes and weights of aircraft. The aircraft tractors either need to generate sufficient power to be able to pull or push the largest of aircraft, or there needs to be provided a multiplicity of aircraft tractors to be used for different classes of aircraft.

There are disadvantages with both of these solutions: a single aircraft tractor with a sufficiently large engine to provide power to the largest aircraft will waste a great deal of energy when towing lighter aircraft; conversely having a variety of sizes of aircraft tractor requires a greater initial expenditure for the owner.

When towing an aircraft, peak power is required during initial acceleration. Once there is sufficient forward momentum to overcome the so-called inertial barrier, the power required for moving the aircraft is significantly reduced. With present tractors, because the engine is providing the driving power directly through the transmission, the engine must be powerful enough to provide the peak power.

Due to the operating pattern of an aircraft tractor, up to 25% of the time may be spent with the engine idling. The larger the engine, the more fuel will be wasted during this idle time. Larger engines also require more maintenance than smaller versions, leading to both increased costs and time wasted whilst a tractor is undergoing repairs.

It would therefore be optimal to provide a means of powering an aircraft tractor or mover wherein the initial power delivery was high, but reduced considerably once the initial resistance were overcome. This would lead to significant reductions in fuel requirements, and a smaller (and cheaper) engine could be provided.

### SUMMARY

The present disclosure seeks to overcome all of these problems, by providing an electric hybrid aircraft tractor.

According to various embodiments of the disclosure, there is provided a hybrid power delivery system for an aircraft mover that comprises an engine, an electricity generator powerable by the engine, and at least one electric motor providing motive torque to the aircraft mover. The system additionally includes a dual electrical-energy storage and supply system rechargeable by the electricity generator and having different first and second electrical-energy storage and supply means, a controller for controlling power delivery from the dual electrical-energy storage and supply system to the at least one electric motor, and power feedback means for relaying information about the power provided by the at least one electric motor to the controller, whereby the controller selects either or both different first and second electrical-energy storage and supply means to drive the at least one electric motor.

Rather than using direct transmission from the compression combustion engine to drive a driving axle, as in currently available aircraft tractors or movers, the drive to the wheels is provided by at least one electric motor, typically one motor per wheel. There is a main compression-ignition internal combustion engine powering an electricity generator, which charges the energy storage device, but the main compression combustion engine no longer directly drives the driving axle.

In various instances, the engine may be a compression-ignition internal combustion engine.

In various embodiments, the electricity generator may be continuously operable during power delivery to the at least one electric motor.

One of the electric motors may be provided with each wheel of the aircraft mover, each electric motor individually providing torque to its respective wheel.

The compression-ignition internal combustion engine may be automatically operable at a constant optimum speed to provide energy to the dual electrical-energy storage and supply system via the electricity generator.

In various instances, the second electrical-energy storage and supply means may have a fast charge and discharge of electrical-energy relative to the first electrical-energy storage and supply means, and the first electrical-energy storage and supply means may include a battery, and the second electrical-energy storage and supply means may include a super-capacitor array. Peak power may, in various instances, be providable by discharge of the super-capacitor array and normal operating power is providable by the battery.

The dual electrical-energy storage and supply system may be fully or substantially fully chargeable by the electricity generator and supplementarily chargeable by energy recuperation from the at least one electric motor.

The hybrid power delivery system may further comprise charge feedback means for determining a charge level of the dual electrical-energy storage and supply system, and a charging module for selectively charging the dual electrical-energy storage and supply system. The charging module may be able to receive an output from the charge feedback means, and charges the dual electrical-energy storage and supply system from the electricity generator and/or electric motor as necessary if a predetermined charge level is reached.

The system may also comprise energy harvesting means for recuperating energy for the dual electrical-energy storage and supply system, which may include one or more of: a deceleration energy-capture unit; a braking energy-capture unit; and a hydraulic energy capture unit.

According to various other embodiments of the disclosure, there is provided a dual electrical-energy storage and supply system and controller for controlling a distribution of power of an electric hybrid aircraft mover, that comprises a first electrical-energy storage and supply means, a second electrical-energy storage and supply means having a fast charge and discharge of electrical-energy relative to first electrical-energy storage and supply means, a controller for controlling power delivery from the dual electrical-energy storage and supply system to torque generation means of the electric hybrid aircraft mover, and power feedback means for relaying a power requirement of the torque generation means to the controller, the dual electrical-energy storage and supply system being controllable by the controller, so that either or both first and second energy storage and supply means output to the torque generation means dependent upon the power requirement. The first electrical-energy storage and supply means may include a battery, and/or the second electrical-energy storage and supply means may include a super-capacitor array.

According to yet other embodiments of the disclosure, there is provided a method of moving an aircraft using an aircraft mover, wherein the method comprises: a] accelerating the aircraft coupled to the aircraft mover up to speed using one or more electric motors drivable by at least a fast-discharge electrical-energy storage and supply device during a high-power requirement of the aircraft mover; and b] substantially maintaining a speed of the coupled aircraft using at least a slow-discharge electrical-energy storage and supply device during a low-power requirement of the aircraft mover. The method additionally comprises: c] monitoring a charge status of the slow-discharge and fast-discharge electrical-energy storage and supply devices, and when a predetermined charge status is reached, charging the slow discharge and/or fast-discharge electrical-energy storage and supply devices via an onboard electricity generator of the aircraft mover; and d] regeneratively recharging the slow-discharge and/or fast-discharge electrical-energy storage and supply devices during at least deceleration of the coupled aircraft.

The torque needed to drive the aircraft tractor in different instances of its operation varies considerably. As such, an intelligent system for controlling the power delivery to the tractor, whereby only the power needed for each instance were transmitted to the torque generation means, would be highly advantageous.

To achieve this goal, there is a requirement to both monitor the torque requirement of a given operation, and to supply the correct power to provide the torque. As such, there is a requirement for a torque generation device which can be variably powered. This is most easily achieved by utilizing an electric hybrid system, wherein power can be provided from multiple energy storage and supply devices with differing rates of discharge.

In operation a], the slow-discharge electrical-energy storage and supply device may supplement the fast-discharge electrical-energy storage and supply device supplying the one or more electric motors.

Additionally or alternatively, in operation a], the fast-discharge electrical-energy storage and supply device may be a primary motive energy output device, and the slow-discharge electrical-energy storage and supply device may be a secondary motive energy output device having a lower initial energy potential than the fast-discharge electrical-energy storage and supply device.

In various instances, in operation b], the slow-discharge electrical-energy storage and supply device may be a primary motive energy output device, and the fast-discharge electrical-energy storage and supply device may be a secondary motive energy output device having a faster discharge time than the slow-discharge electrical-energy storage and supply device.

In operation c], the onboard electricity generator may operate in operation a] and/or operation b] to supplementarily charge the slow-discharge and/or the fast-discharge electrical-energy storage and supply devices.

In various embodiments, in operation c], a drive output to wheels of the aircraft mover may be provided solely by at least one electric motor.

Furthermore, in operation a], at least a portion of the aircraft may be lifted using power supplied by one or both of the slow-discharge and fast-discharge electrical-energy storage and supply devices, and in operation d], regenerative recharging of the slow discharge and/or fast-discharge electrical-energy storage and supply devices may also further occur during lowering of the aircraft.

The slow-discharge and fast-discharge electrical-energy storage and supply devices may include one or more batteries and one or more super-capacitors, respectively. The method may utilize a hybrid power delivery system for an aircraft mover, in accordance with various embodiments of the disclosure, or a dual electrical-energy storage and supply system and controller for controlling a distribution of power of an electric hybrid aircraft mover, in accordance with various other embodiments of the disclosure.

According to various other embodiments of the disclosure, there is provided a method of controlling the distribution of power of an electric hybrid aircraft mover having a dual electrical-energy storage and supply system including first and second electrical-energy storage and supply means, the second electrical-energy storage and supply means having a fast charge and discharge of electrical-energy relative to first electrical-energy storage and supply means, wherein the method comprises: a] determining a required peak power for at least accelerating an attached aircraft; b] calculating the energy required to provide the peak power; c] determining whether sufficient peak power will be generated solely from energy from the first energy storage and supply means; and d] providing energy from second energy storage and supply means if power is determined to be insufficient in operation c].

The advantages of the methods described in the various embodiments of the disclosure are that the dual electrical-energy storage and supply means contains multiple electrical-energy storage and supply means, each capable of providing power, but with different capacities and discharge rates. This means that a rapid delivery of power can be achieved when peak power is required, but that normal powering of the tractor can be achieved through the more long-lived first energy storage and supply means.

In various instances, in operation b], a peak power requirement may be at least substantially continuously calculated during operation of the aircraft mover.

In various instances, in operation a] the peak power may include lifting at least part of an aircraft.

The method may further comprise e] subsequent to operation d] of recharging the first and second electrical-energy storage and supply means via an internal-combustion generator onboard the aircraft mover, and the first and second electrical-energy storage and supply means may be further recharged in operation e] from energy harvesting means associated with at least one power delivery system of the aircraft mover. The aircraft mover may be an aircraft tractor comprising at least four wheels, and each wheel may include at least an associated electric motor.

The method may utilize a hybrid power delivery system for an aircraft mover, in accordance with various embodiments of the disclosure, or a dual electrical-energy storage and supply system and controller for controlling a distribution of power of an electric hybrid aircraft mover, in accordance with various other embodiments of the disclosure.

According to yet other embodiments of the disclosure, there is provided a method of powering an electric hybrid aircraft mover having a dual electrical-energy storage and supply system including first and second electrical-energy storage and supply means, the second electrical-energy storage means having a fast charge and discharge of electrical-energy relative to the first electrical-energy storage and supply means, wherein the method comprises: a] using the second energy storage means to provide initial peak power to at least accelerate the aircraft mover and an attached aircraft; b] monitoring the power requirement over time; and c] powering the aircraft mover from the first electrical-energy storage and supply means once a power requirement falls below a predetermined threshold.

In various instances, this method utilizes a hybrid power delivery system for an aircraft mover in accordance with various embodiments of the disclosure or a dual electrical-energy storage and supply system and controller for controlling a distribution of power of an electric hybrid aircraft mover in accordance with various other embodiments of the disclosure.

This summary is provided merely for purposes of summarizing various example embodiments of the present disclosure so as to provide a basic understanding of various aspects of the teachings herein. Various embodiments, aspects, and advantages will become apparent from the following detailed description taken in conjunction with the accompanying drawings which illustrate, by way of example, the principles of the described embodiments. Accordingly, it should be understood that the description and specific examples set forth herein are intended for purposes of illustration only and are not intended to limit the scope of the present teachings.

### DRAWINGS

The teachings of present disclosure will now be more particularly described, by way of example only, with reference to the accompanying drawings, in which:

FIG. 1 shows a perspective view of an electric hybrid aircraft tractor, incorporating drive, supply and control systems and utilizing methods, shown with the undercarriage of an aircraft, in accordance with various embodiments of the present disclosure;

FIG. 2 shows a top down view of the tractor shown in FIG. 1, in accordance with various embodiments of the present disclosure;

FIG. 3 shows a schematic view of a power delivery system, in accordance with various embodiments of the present disclosure and incorporated as part of the tractor shown in FIGS. 1 and 2;

FIG. 4 shows an example of a power delivery curve over time required when the tractor is towing a laden aircraft, utilizing the power delivery system of FIG. 3, in accordance with various embodiments of the present disclosure;

FIG. 5 diagrammatically depicts a method of controlling the delivery of power to the aircraft tractor, in accordance with various embodiments of the disclosure; and

FIG. 6 diagrammatically depicts a method of powering the aircraft tractor, in accordance with various embodiments of the disclosure.

### DETAILED DESCRIPTION

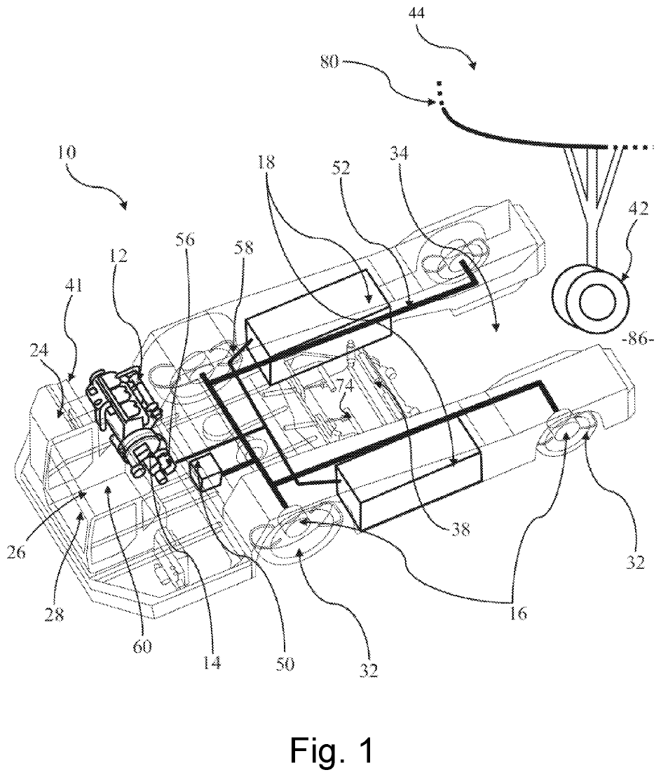

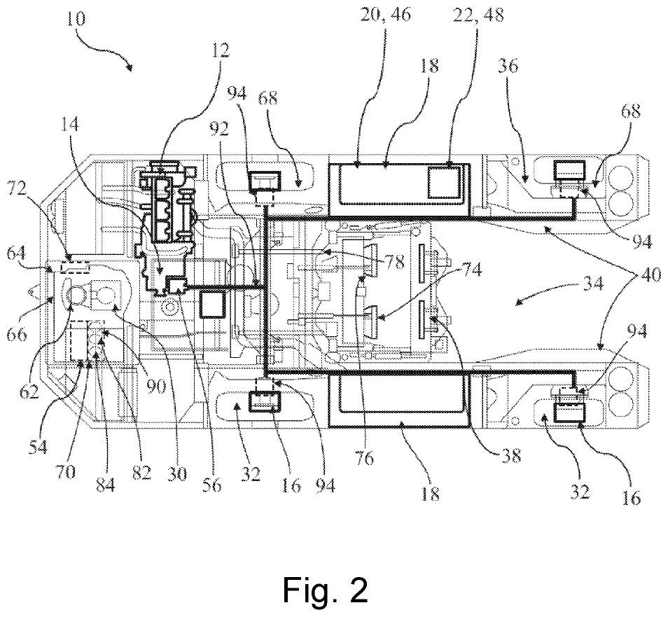

With reference firstly to FIGS. 1 and 2 of the drawings, there is shown an aircraft tractor 10, which is an electric hybrid aircraft mover vehicle, having a compression ignition internal combustion engine, in this case a diesel engine 12, electricity generator 14 and at least one electric motor 16. There is also provided a dual electrical-energy storage and supply system 18, including a first electric-energy storage and supply means 20, and a second electric-energy storage and supply means 22, which is different to the first energy storage means 20.

The aircraft tractor 10 comprises a chassis 24, a cabin 26, in various instances located at a front end 28 of the tractor 10, from which an operator 30 may control the tractor 10, a plurality of wheels 32, and an aircraft engagement area 34 located at the rear 36 of the tractor 10. Typically, the aircraft tractor 10 has four wheels 32, but tractors or other kinds of aircraft mover with different numbers of wheels can be envisioned.

The aircraft engagement area 34 includes a lifting mechanism 38 located between two outer sections 40 of the chassis 24. The outer sections 40 extend separately from the rear of an engine-mounting portion 41 of the chassis 24, and are sufficiently spaced apart from one another so as to provide space for accepting at least a nose landing gear 42 of an aircraft 44.

The diesel engine 12 is typically located forwardly on the chassis 24 of the tractor 10, and is the primary recharging power source of the tractor 10. The engine 12 provides power to the electricity generator 14 which generates electrical-energy. The electricity generator 14 is coupled to the dual electrical-energy storage and supply system 18, typically comprising at least one battery pack 46 and a super-capacitor array 48, forming at least in part the first and second energy storage and supply means 20, 22, respectively.

The dual electrical-energy storage and supply system 18 is connected to a controller 50, which controls the distribution of power from either the first or second energy storage and supply means 20,22 to the motors 16 of the tractor 10 and/or the lifting mechanism 38.

The controller 50 is connected to a power feedback means 52, which is in turn connected to the electric motors 16, and monitors the torque and/or power provided by the motors 16 to the wheels 32, relaying the information back to the controller 50.

Located within the cabin 26 is a power control input 54 for issuing commands to a charging module 56, for selectively recharging the dual electrical-energy storage and supply system 18. The generator 14 is in electrical communication with the charging module 56, which supplies electricity to the at least one battery pack 46 and super-capacitor array 48.

There is also provided a charge feedback means 58, which monitors the charge remaining in the first and second energy storage and supply means 20, 22. The charge feedback means 58 is connected to the charging module 56, allowing the charging module 56 to use the information relayed from the charge feedback means 58 to determine when to supply the dual electrical-energy storage and supply system 18 with electricity from the generator 14.

From inside the cabin 26, the operator 30 can pilot the tractor 10. Typically there will be provided a seat 60, steering mechanism, for instance a steering wheel 62, acceleration means 64 and braking means 66. Triggering the acceleration means 64 will drive the at least one electric motor 16 to accelerate the tractor 10, allowing the operator 30 to pilot the tractor 10.

The at least one electric motor 16 is used to provide the motive torque to the wheels 32 of the tractor 10. Typically, one electric motor 16 will be associated with each wheel 32 of the tractor 10, such that each motor 16 can individually provide torque to its respective wheel 32.

The power for the at least one electric motor 16 is provided from the dual electrical-energy storage and supply system 18. Each motor 16 is electrically connected to the dual electrical-energy storage and supply system 18, which can provide energy from either the first or second energy storage and supply means 20, 22, as required.

Each electric motor 16 would typically be located within a hub 68 of each respective wheel 32 acting as a torque generation means for each wheel 32. It will, however, be appreciated that the driving of wheels 32 individually is not the only arrangement for the at least one electric motor 16, for instance, an electric motor 16 could be associated with a driving axle of a pair of wheels 32 in the aircraft tractor 10, or even motor-drivable wheels associated with caterpillar tracks can be envisioned.

Within the cabin 26, along with the power control input 54 for issuing commands to the charging module 56, a lifting control panel 70 is also provided for controlling the lifting mechanism 38. There may also be a charge display unit 72 which displays information to the operator 30 from the charge feedback means 58 regarding a charge level of the battery 46 and/or super-capacitor array 48.

The lifting mechanism 38 comprises one or more clamps 74 which are capable of engaging with the nose landing gear 42 of an aircraft 44. The clamps 74 are engaged with the nose landing gear 42 using actuation means 76, typically hydraulic pistons. The lifting mechanism 38 further comprises one or more hydraulic motors 78, for lifting the nose landing gear 38, and therefore front 80 of the aircraft 44, during operation.

The lifting mechanism 38 is remotely controllable by the operator 30 by using the lifting control panel 70. There is included an actuation control means 82 and a lifting control means 84 as part of the lifting control panel 70, for respectively controlling the actuation means 76 and hydraulic motors 78 of the lifting mechanism 38.

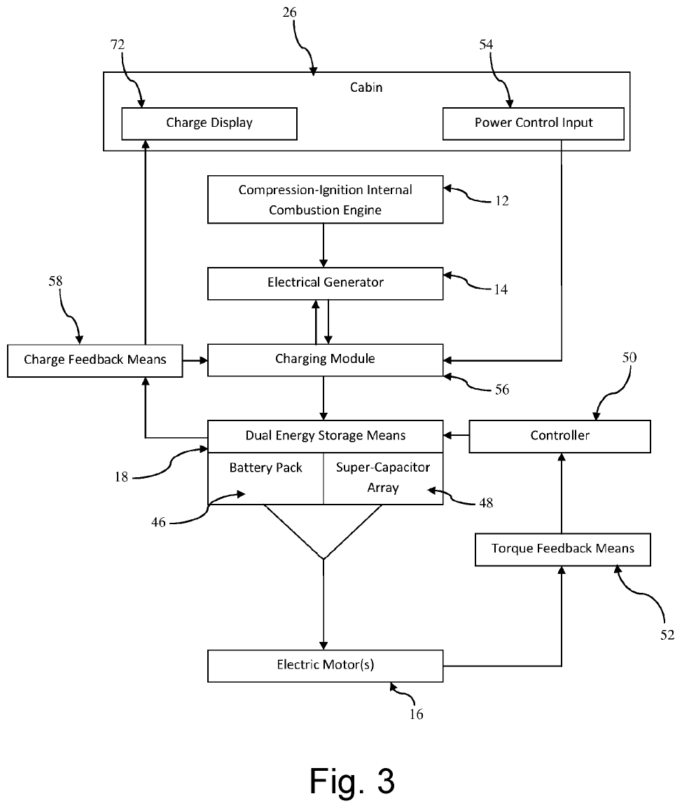

The total power delivery system is illustrated in FIG. 3. When the aircraft mover 10 is in use, the compression-ignition internal combustion engine 12 will, in various instances, be running continuously. This continuously powers the electricity generator 14, which generates electricity. The electricity generator 14 is in communication with a charging module 56, which diverts the electricity to the dual electrical-energy storage and supply system 18. The dual electrical-energy storage and supply system 18 then provides power to the electric motors 16 of the tractor, which drive the wheels 32.

The dual electrical-energy storage and supply system 18 is comprised of two parts: a battery pack 46 and a super-capacitor array 48. Either of these energy storage and supply means may provide the energy to the electric motors 16, depending on the power required for a particular operation. If a fast discharge of power is required, for example, accelerating an attached aircraft 44, then the super-capacitor array 48 will discharge. Under normal operating conditions, the battery pack 46 will provide the power to the motors 16.

Switching between the battery pack 46 and super-capacitor array 48 is performed by a controller 50, which receives a signal from a power feedback means 52. The power feedback means 52 is in communication with the electric motors 16, and monitors the torque output for a given operation. If the power requirement is larger than can be provided by the motors 16 when powered from the battery pack 46, the controller 50 switches the dual electrical-energy storage and supply system 18 so as to provide power from the super-capacitor array 48. In this case, all motive power may be outputted by the super-capacitor array 48 acting as a primary supply, or may be supplemented by the battery pack 46 acting as a secondary supply.

The dual electrical-energy storage and supply system 18 will discharge over the course of operating the tractor 10, so there is also included a charge feedback means 58 interposed between the dual electrical-energy storage and supply system 18 and the charging module 56. If the charge of the dual electrical-energy storage and supply system 18 is depleted, the charging module 56 will divert electricity from the electricity generator 14 to recharge the dual electrical-energy storage and supply system 18, during movement of the tractor if necessary.

The charge feedback means 58 may also output a signal to a charge display 72 within the cabin 26. This allows the operator 30 to see the remaining charge in the dual electrical-energy storage and supply system 18. In the cabin 26, there is further provided a power control input 74 which may be activated by the operator 30. Activating the power control input 74 will force the charging module 56 to divert electricity from the electricity generator 14 to the dual electrical-energy storage and supply system 18.

In use, the operator 30 may reverse the tractor 10 towards the nose landing gear 42 of the aircraft 44, aligning the lifting mechanism 38 with the nose landing gear 42. The operator 30 then remotely operates the clamps 74 of the lifting mechanism 38 so as to engage the nose landing gear 42.

Once the clamps 74 are securely fastened to the nose landing gear 42, the operator 30 activates the hydraulic motors 78 of the lifting mechanism 38, thus raising the front of the aircraft 44 upwardly away from the ground 86. With the aircraft 44 raised, the tractor 10 is then able to tow and maneuver the aircraft 44 along a runway, pushback from a terminal, or transition the aircraft from or to a hanger. This process has variable power requirements.

Peak power is required during acceleration, given the weight of a standard commercial aircraft, the inertial barrier to be overcome is typically very large. However, both prior to the acceleration of the tractor 10, and after the inertial barrier has been overcome, the power requirement becomes significantly lower.

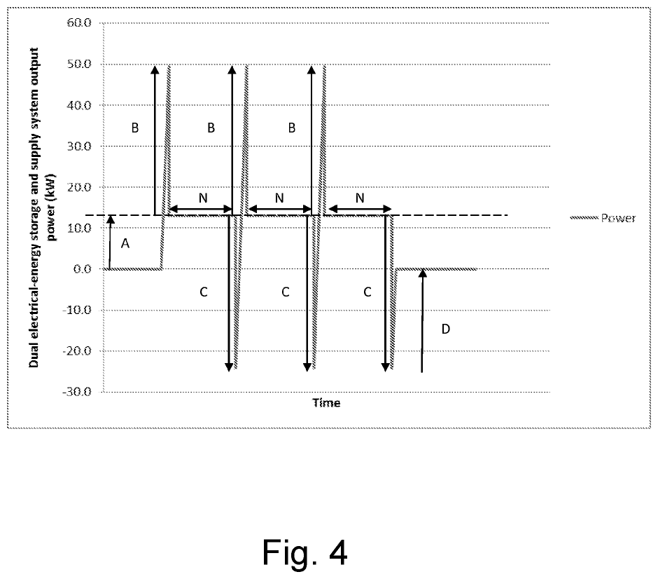

A typical duty cycle for an in-use aircraft tractor 10 can be seen in FIG. 4, showing a laden aircraft 44. The output power of the dual electrical-energy storage and supply system 18 over time is plotted in the graph. The numerical values of the output power are for illustrative purposes only, since it will be appreciated that different aircraft, both laden (e.g., containing passengers and baggage) and unladen, will require different amounts of power to raise and accelerate.

To control the power distribution to the wheels 32 or lifting mechanism 38 between the battery pack 46 and super-capacitor array 48, the type of aircraft 44 to be towed is, in various instances, first selected by the tractor operator 30, for example, via a selection panel 90 in the cabin 26, which may be incorporated into the lifting control panel 70. Whether the aircraft 44 is laden or unladen is also, in various instances, selected, since this significantly alters an overall weight that the tractor 10 must accommodate and thus power requirement.

Following this selection, the controller 50 determines a required peak power. Once the controller 50 has determined the peak power requirement, the energy requirement to achieve the peak power is then determined by the controller based on predetermined and preloaded aircraft types, conditions and requirements.

In order to provide the necessary torque to achieve peak power in a short space of time with the/or each electric motor 16, a large energy discharge is required. The super-capacitor array 48 has a relatively fast discharge, and is used to provide a rapid surge of power. Once the inertial barrier has been overcome, however, there is a much reduced power, and therefore torque, requirement.

Switching between the first and second energy storage and supply means 20, 22 is performed by the controller 50. When the controller 50 receives the relevant information, it will switch between the first and second energy storage and supply means 20, 22. The point of switching is calculated by determining a required peak power for at least accelerating an aircraft 44 attached to the lifting mechanism 38 of the tractor 10, and calculating the energy required to provide the peak power. By then determining whether sufficient peak power will be generated solely from energy output from the battery pack 46, it can be determined by the controller 50 whether to instead provide energy solely from the super-capacitor array 48, if power from the battery pack 46 is determined to be insufficient.

As the lifting mechanism 38 raises the nose landing gear 42 of the aircraft 44, a certain proportion of the peak power is required. This is illustrated by reference A in FIG. 4. The lifting of the nose landing gear 38 will be powered by either the first energy storage and supply means 20, e.g., from the battery pack 46, or the second energy storage and supply means 22, e.g., from the super-capacitor array 48. Which of the first and/or second energy storage and supply means 20, 22 will be used will be dependent upon the weight, and therefore power required to lift, the aircraft 44 clear of the tarmac 68.

Peak power is required to accelerate the tractor 10 and aircraft 44 coupled thereto, as illustrated by reference B in FIG. 4. At this point, the controller 50 may have determined that the power required for acceleration is insufficient via feedback from the power feedback means 52. As such, the controller 50 will automatically switch the power output of the dual electrical-energy storage and supply system 18 to the super-capacitor array 48 so as to provide a short-term fast energy discharge allowing the tractor 10 to accelerate the aircraft 44 to the determined speed.

Under standard driving conditions, illustrated by reference N in FIG. 4, the power feedback means 52 will output a signal to the controller 50, which will then switch the dual electrical-energy storage and supply system 18 back to the battery pack 46.

Once the aircraft 44 has reached the substantially constant velocity of normal driving conditions, and therefore the initial inertial resistance has been overcome, the controller 50, by continuously monitoring the power requirement of the electric motors 16 via the power feedback means 52, may seamlessly switch the energy storage and supply means 22 from the fast-discharge super-capacitor array 48 to the relatively slower discharge battery pack 46 and vice versa. Since a short-term high peak power may no longer be required, once the aircraft 44 is moving, the battery pack 46, for example, being a Lithium-Ion or Metal Nickel Hydride battery pack 46, can be utilized to provide a longer-term lower power but constant voltage to the electric motors 16. If a short term high power requirement is determined, such as moving up an incline at constant velocity, the controller 50 may switch to the fast-discharge super-capacitor array 48 for a brief period. In this situation, the battery pack 46 is thus the primary supply, and the super-capacitor array 48 is the secondary supply which supplements the primary supply as required. It will be apparent, however, that a battery pack and super-capacitor array are by no means the only possible slow- and fast-discharge electrical-energy storage and supply means, and other such devices can be used instead.

When the aircraft 44 is required to decelerate, the power requirement of the dual electrical-energy storage and supply system 18 drops significantly. This is illustrated by reference C in FIG. 4. If the tractor 10 comes to a halt, and lowers the aircraft 44, then the power required of the dual electrical-energy storage and supply system 18 will drop to zero, as illustrated by reference D.

Whichever energy storage and supply means 20, 22 is being used, the controller 50 may at any time determine that it should be supplemented or substituted by the remaining energy storage and supply means 20, 22. Consequently, in all cases, the secondary supply may operate simultaneously with or independently of the primary supply, as required.

During the acceleration period, the overall charge in the first and second energy storage and supply means 20, 22, and therefore in the dual electrical-energy storage and supply system 18 will decrease. Energy harvesting means 92 for recuperating energy by conversion of kinetic or hydraulic energy, for example, energy lost during deceleration, braking and lowering of the aircraft 44, into electrical-energy is provided, and this recovered energy is fed back into the dual electrical-energy storage and supply device 18 via the charging module 56.

It may be advantageous therefore to recuperate electrical-energy during stage C (see FIG. 4) of the duty cycle to supplement the charging of the dual electrical-energy storage and supply device 18, in addition to the energy provided by the generator 14. Note that energy recuperation may be possible even if the dual electrical-energy storage and supply device 18 was in a state of net power output. For instance, regenerative braking may be possible during deceleration, even though the dual electrical-energy storage and supply device 18 is expending power maintaining the lift of the nose landing gear 42 of an aircraft 44.

The energy harvesting means 92 utilizes an energy recuperation unit 94 installed on the tractor 10 to take advantage of energy gain. The unit 94 may typically be anyone or more of a deceleration energy-capture unit, a braking energy-capture unit, a hydraulic energy-capture unit, or any combination thereof. It will be appreciated that the possible types of energy recuperation units 94 are not limited to those mentioned here, however, and other energy harvesting means 92 can be alternatively or additionally utilized, such as vibrational energy recuperation.

Potential energy recuperation routes are through braking of the tractor 10, via regenerative braking, increases in hydraulic pressure due to lowering of the aircraft 44, or general energy recapture from deceleration of the tractor 10.

Due to the dual electrical-energy storage and supply system 18 incorporated as part of the tractor 10, the diesel engine 12 as mentioned above can be significantly reduced in power. The diesel engine 12 is, in various instances, set to automatically run at a constant optimum speed during movement and/or operation of the tractor to provide energy to the dual electrical-energy storage and supply system 18, maintaining a constant or substantially constant level of charge within the battery 20 and the super-capacitor array 22. Advantageously, this allows for the smaller, more-efficient engine 12 to be constantly powering the generator 14, which keeps the first and second energy storage and supply means 20, 22 charged.

Using a smaller, more efficient engine 12 has the advantage of greatly reducing fuel consumption over the lifetime of the tractor 10, in addition to reducing the carbon emissions of the tractor 10.

As previously mentioned, the charge of the dual electrical-energy storage and supply system 18 will drain during use. The dual electrical-energy storage and supply system 18 is recharged via the charging module 56, which is in turn supplied by the generator 14. The charge feedback means 58 is interposed between the charging module 56 and the dual electrical-energy storage and supply system 18, providing feedback to the charging module 56. The charge feedback means 58 is typically a simple feedback circuit, but any appropriate feedback means could be utilized, such as a Smart Battery management system.

When the dual electrical-energy storage and supply system 18 is at least partially depleted, the charging module 56 may direct electricity from the generator 14 to charge the dual electrical-energy storage and supply system 18. This may be performed automatically, continuously and/or, in various instances, when a predetermined charge status or level is monitored.

The charge feedback means 58 may beneficially output to the charge display unit 72, displaying the remaining charge level to the operator 30. Within the cabin 26, the power control input 54 is, in various instances, in communication with the charging module 56. The power control input 54 allows the operator 30 to manually request that the charging module 56 specifically draws power from the generator 14 into the dual electrical-energy storage and supply system 18, thus recharging the first and second energy storage and supply means 20, 22. This may be useful if the battery 46 and/or super-capacitor array 48 have been particularly drained by an operation, or more typically prior to the performance of a lifting and/or maneuvering operation to make sure the battery 46 and super-capacitor array 48 are fully charged or topped off.

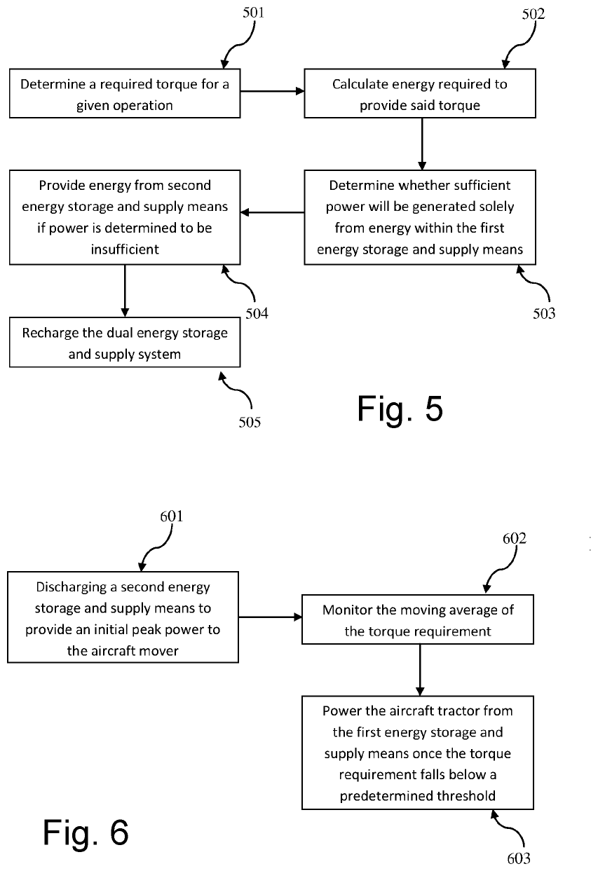

The general switching process is illustrated in FIG. 5. A required torque for a given operation is determined by the controller 50 in conjunction with the power feedback means 52, indicated at reference 501, and an energy required to provide the torque is calculated, indicated at reference 502. The controller 50 then determines whether sufficient power will be generated solely from energy within the first energy storage and supply means 20, indicated at reference 503, and if this is determined to be insufficient, the controller 50 will provide power to the electric motors 16 from the second energy storage and supply means 22, this being indicated at reference 504. Finally, indicated at reference 505, as the dual electrical-energy storage and supply system 18 becomes depleted, the charging module 56, in conjunction with the charge feedback means 58, will divert electricity from the electricity generator 14 to recharge the dual electrical-energy storage and supply system 18.

The reverse is shown in FIG. 6. The second energy storage and supply means 22 is discharged so as to provide an initial peak power to the aircraft mover 10, this being indicated at reference 601. The moving average of the power requirement of the electric motors 16 can then be monitored by the power feedback means 52, and fed back to the controller 50, indicated at reference 602. With this information, the controller 50 can then switch the dual electrical-energy storage and supply system 18 to power the electric motors 16 from the first energy storage and supply means 20, once the power requirement falls below a predetermined threshold, this being indicated at reference 603.

It will be appreciated that a dual electrical-energy storage and supply system 18 and controller 50 could be retroactively installed on present generation aircraft tractors 10 or movers, which would allow them to take advantage of all of the benefits detailed above. Retrofitting existing tractors 10 or other kinds of aircraft movers would be considerably cheaper than building a new aircraft mover, whilst passing on the cost savings associated with the reduced fuel consumption from the smaller engine 12.

Although, in various instances, a compression-ignition internal combustion engine is provided, the engine may be a spark-ignition internal combustion engine, a turbine, or other suitable kind of engine.

Furthermore, although an aircraft tractor is described by way of example, the above described embodiments can be applied to other types of aircraft mover, such as remotely controllable movers, and/or those with wheels that drive caterpillar tracks.

There is thus provided a method of controlling the distribution of power of an electric hybrid aircraft tractor or other kinds of aircraft mover incorporating a dual electrical-energy storage and supply system having first and second energy storage means. This advantageously allows the aircraft mover to utilize a considerably smaller main engine than is traditionally required to lift and maneuver an aircraft. Utilizing the smaller main engine to supply a charging system outputting to the dual electrical-energy storage and supply system instead of driving the wheels thus requires a much lower peak power demand.

The electric hybrid aircraft tractor has at least one electric motor which drives the wheels of the tractor, which is powered by the dual electrical-energy storage and supply system instead of the internal combustion engine. There is also provided a controller to control the switching of the dual electrical-energy storage and supply system between first and second energy storage and supply means.

To overcome a potential lack of power due to the utilization of the smaller than traditional main engine, the second energy storage and supply means has a fast rate of discharge and short-term high voltage capability relative to the first energy storage and supply means. This allows the electric motors and associated lifting gear if required to reach high peak power for a short period of time, thus providing sufficient power particularly to the wheels to overcome initial resistance to motion. The first and second electrical-energy storage and supply means may operate in unison and/or alternately, and may conveniently be charged on the fly by the onboard engine supplying an electricity generator during a maneuvering and/or lifting operation to ensure a maximum charge level is available at substantially all times.

The words ‘comprises/comprising’ and the words ‘having/including’ when used herein with reference to the present disclosure are used to specify the presence of stated features, integers, steps or components, but do not preclude the presence or addition of one or more other features, integers, steps, components or groups thereof.

It is appreciated that certain features of the disclosure, which are, for clarity, described in the context of separate embodiments, may also be provided in combination in a single embodiment. Conversely, various features of the disclosure which are, for brevity, described in the context of a single embodiment, may also be provided separately or in any suitable sub-combination.

The embodiments described above are provided by way of examples only, and various other modifications will be apparent to persons skilled in the field without departing from the scope of the disclosure as defined herein.

What is claimed is:

1. An aircraft mover comprising:
an internal combustion engine;
an electricity generator powered by the internal combustion engine;
a dual electrical-energy storage and supply system configured to receive power from the electricity generator, the dual electrical-energy storage and supply system comprising:
a first battery pack; and
a second battery pack;
at least one electric motor electrically connected to the dual electrical-energy storage and supply system and operable to provide drive torque for moving the aircraft mover; and
a chassis comprising:
a forward section;
an aircraft engagement area;
a first outer section; and
a second outer section spaced apart from the first outer section,
wherein the first battery pack is disposed within the first outer section and the second battery pack is disposed within the second outer section.

2. The aircraft mover of claim 1, wherein the internal combustion engine and electricity generator are mounted to the forward section of the chassis.

3. The aircraft mover of claim 1, wherein the dual electrical-energy storage and supply system is structured and operable to receive supplementary charge by energy recuperation from the at least one electric motor.

4. The aircraft mover of claim 1, wherein the internal combustion engine is set to automatically run at a predetermined optimum speed to provide energy to the dual electrical energy storage and supply system.

5. The aircraft mover of claim 1, further comprising a charge feedback circuit that determines a charge level of the dual electrical-energy storage and supply system

6. The aircraft mover of claim 5, further comprising a charge module configured to direct charge from the generator to the dual electrical-energy storage and supply system based at least in part on the charge level of the dual electrical energy storage and supply system.

7. The aircraft mover of claim 1, further comprising a plurality of wheels connected to the chassis.

8. The aircraft mover of claim 7, wherein the at least one electric motor further includes a first, second, third, and fourth electric motor, wherein each of the first, second, third and fourth electric motor provides torque to a different one of the plurality of wheels.

9. The aircraft mover of claim 7, wherein the plurality of wheels further includes a first and second row of wheels, wherein the first row of wheels is mounted closer to the front of the aircraft mover than the second row of wheels.

10. The aircraft mover of claim 8, wherein the first and second battery packs are mounted rearward the first row of wheels and forward the second row of wheels.
